(19) United States
(12) Patent Application Publication
(10) Pub. No.: US 2026/0262665 A1
(43) Pub. Date: Sep. 10, 2026

(54) NOVEL PROCESS FOR PRODUCING A FERMENTED MILK PRODUCT AND NEW FERMENTED MILK PRODUCT SO PRODUCED

(71) Applicant: DSM IP ASSETS B.V., Maastricht (NL)

(72) Inventors: Fei ZHANG, ECHT (NL); Xiangyan REN, Echt (NL); Haitao HOU, Echt (NL); Xiuqing LI, Echt (NL); Liyi YU, Echt (NL)

(21) Appl. No.: 19/164,410

(22) PCT Filed: Mar. 15, 2024
(86) PCT No.: PCT/EP2024/056948

§ 371 Date: Sep. 11, 2025

(30) Foreign Application Priority Data
Mar. 15, 2023 (WO) PCT/CN2023/081544

(51) Int. Cl. A23C 9/12; A23B 11/13; A23C 9/123; A23C 9/127; A23C 9/13

(52) U.S. Cl. CPC A23C 9/1209; A23B 11/13; A23C 9/123; A23C 9/1275; A23C 9/1307

(57) ABSTRACT

The invention provides a process for the production of a fermented milk product, preferably a yogurt, comprising the steps of:
(a) fermenting the milk-base with one or more lactic acid bacterial strains, a coagulant and a stabilizer to generate a fermented milk product; and
(b) heat treating the fermented milk product at a temperature of at least 70° C. for a period of at least 5 seconds to generate a heat-treated fermented milk product.

Preferably the heat-treated fermented milk product is subsequently stored in a step (c) at a temperature in the range from equal to or more than 10° C. to equal to or less than 40° C.

### FIELD OF THE INVENTION

The invention relates to a novel process for producing a fermented milk product and a new fermented milk product so produced.

In addition, the invention provides a novel kit of parts for use in the above process and/or for producing the new fermented milk product.

### BACKGROUND OF THE INVENTION

Fermented milk products such as yogurts are popular due to their healthy image and pleasant sensory properties, such as taste and texture. During the preparation of fermented milk products, milk is traditionally acidified by bacterial cultures. These bacterial cultures ferment a sugar such as lactose, into an acid, such as lactic acid. Bacterial cultures that ferment lactose to produce lactic acid as their main product are sometimes also referred to as lactic acid bacteria (LAB). The lactic acid assists in giving a fermented milk product its typical aroma. After fermentation the fermented milk products such as yogurts are traditionally cooled to and stored at a refrigerator temperature, such as 4° C. The live lactic acid bacteria cultures remain present in the cooled product.

EP3143879 describes a process for the production of a fermented milk product, preferably yogurt, comprising fermenting the milk with lactic acid bacteria. EP3143879 expresses the desire to avoid texturizing agents, such as stabilizers and gelatin. In the claimed process, the milk is contacted with a polypeptide having chymosin activity, having a C/P ratio higher than the C/P ratio of bovine chymosin, to reduce ripening of the yogurt. In its examples EP3143879 describes the making of a stirred yogurt by fermentation at 42° C. The acidification was monitored at the same temperature. Once a pH of 4.6 was reached, the yogurts were smoothened and filled out in suitable containers. The containers were then stored at 4° C. With the process of EP3143879 good results can be obtained. However, further improvement is desirable.

CN115067394 describes fermented raw cheese and a preparation method thereof. The cheese is prepared by adding Lactobacillus and rennin into milk through homogenizing sterilization and discharging whey after fermentation, and the fermentation flavor is improved through Lactobacillus low-temperature long-time fermentation.

There is an increasing customer demand for ambient fermented milk products, especially ambient yogurts. For example, CN103598328 describes a process for preparation of ambient yoghurt. The preparation method comprises the following steps: mixing materials to obtain a mixed material solution; carrying out heat treatment on the mixed material solution under the temperature ranging from 110° C. to 140° C. until the thermotropy rate of whey proteins in the mixed material solution is more than 89% to obtain a heat-treated material solution; inoculating lactic acid bacteria into the heat-treated material solution and fermenting to obtain a fermented material; and sterilizing the fermented material.

Unlike traditional refrigerated yogurts, ambient yogurts need to remain stable at room temperature and are not refrigerated. Therefore, unlike refrigerated yogurts, ambient yogurts require an extra heating step after fermentation to destroy undesired micro-organisms. This heat treatment does not only destroy undesired micro-organisms, but also destroys the lactic acid bacteria. Thus, the ambient yogurts no longer contain any live lactic acid bacterial cultures. A disadvantage in ambient yogurts is that the texture of the ambient yogurt can become grainy and/or small lumps may be formed. The ambient yogurts according to the prior art thus develop a rough taste.

It would be an advancement in the art to provide a process for producing an ambient fermented milk product with an improved texture, especially an improved smoothness, and to provide a smooth ambient fermented milk product so produced.

### SUMMARY OF THE INVENTION

The invention advantageously provides a novel process for producing a fermented milk product, especially an ambient fermented milk product, wherein an improved texture, especially an improved smoothness, is obtained by combining the use of a stabilizer and a coagulant, such as a polypeptide having chymosin activity. As indicated above, ambient fermented milk products require a heat treatment after fermentation to destroy undesired micro-organisms. Denaturation of enzymes, such as coagulants, already occurs at temperatures in the range between 45° C. and 55° C. Enzymes are thus not expected to survive the heat treatment needed to destroy undesired micro-organisms. The post heat treatment effects are therefore a surprise.

Accordingly, in a first aspect, the invention provides a process for the production of a fermented milk product, preferably a yogurt, comprising the steps of:
(a) fermenting the milk-base with one or more lactic acid bacterial strains, a coagulant and a stabilizer to generate a fermented milk product; and
(b) heat treating the fermented milk product at a temperature of at least 70° C. for a period of at least 5 seconds to generate a heat-treated fermented milk product.

Preferably the heat-treated fermented milk product is subsequently stored in a step (c) at a temperature in the range from equal to or more than 10° C. to equal to or less than 40° C.

Preferably the coagulant is a polypeptide having chymosin activity.

In a second aspect, the invention provides a fermented milk product, preferably a yogurt, obtained or obtainable by such process. That is, suitably the invention also provides a fermented milk product, preferably a yogurt, comprising: (i) one or more inactivated lactic acid bacterial strains; (ii) one or more inactivated coagulants; and (iii) a stabilizer.

In a third aspect, the invention provides a kit of parts comprising
one or more lactic acid bacterial strains;
a coagulant, preferably a polypeptide having chymosin activity; and
a stabilizer.

Preferably the kit of parts further comprises a non-reducing, disaccharide, oligosaccharide or polysaccharide, most preferably sucrose.

This novel kit of parts can advantageously be used in the above process and/or for producing the above fermented milk product.

In a fourth aspect, the invention provides a use of a combination of a stabilizer and a coagulant, preferably a polypeptide having chymosin activity, in the preparation of a fermented milk product, preferably a yogurt, more preferably an ambient yogurt.

Inventors found that the above allows for the production of an ambient fermented milk product that comprises a texture with improved smoothness.

### BRIEF DESCRIPTION OF THE DRAWINGS

The invention is illustrated by the following figures:

FIG. 1 illustrates the viscosity of the yogurt samples prepared in examples 1 to 6.

FIG. 2 illustrates the particle size in the yogurt samples prepared in examples 1 to 6.

FIG. 3 provides the visual results of the yogurt samples prepared in examples 1 to 6.

FIG. 4 illustrates the viscosity of the yogurt samples prepared in examples 7 and 8.

FIG. 5 illustrates the particle size in the yogurt samples prepared in examples 7 and 8.

FIG. 6 illustrates the viscosity of the yogurt samples prepared in examples 9 and 10.

FIG. 7 illustrates the particle size in the yogurt samples prepared in examples 9 and 10.

FIG. 8 provides the visual results of the yogurt samples prepared in examples 9 and 10.

FIG. 9 illustrates the particle size in the yogurt samples prepared in examples 11 to 15.

FIG. 10 provides the visual results of the yogurt samples prepared in examples 11 to 15.

FIG. 11 illustrates the viscosity of the yogurt samples prepared in examples 16 and 17.

FIG. 12 illustrates the particle size in the yogurt samples prepared in examples 16 and 17.

FIG. 13 illustrates the viscosity of the yogurt samples prepared in examples 18 and 19.

FIG. 14 illustrates the particle size in the yogurt samples prepared in examples 18 and 19.

FIG. 15 provides the visual results of the yogurt samples prepared in examples 18 and 19.

### DETAILED DESCRIPTION OF THE INVENTION

### Definitions

Unless defined otherwise or clearly indicated by context, all technical and scientific terms used herein have the same meaning as commonly understood by one of ordinary skill in the art.

Throughout the present specification and the accompanying claims, the words “comprise” and “include” and variations such as “comprises”, “comprising”, “includes” and “including” are to be interpreted inclusively. That is, these words are intended to convey the possible inclusion of other elements or integers not specifically recited, where the context allows.

The articles “a” and “an” are used herein to refer to one or to more than one (i.e. to one or at least one) of the grammatical object of the article. By way of example, “an element” may mean one element or more than one element. When referring to a noun (e.g. a compound, an additive, etc.) in the singular, the plural is meant to be included. Thus, when referring to a specific moiety, e.g. a “strain”, this means “at least one” of that strain, e.g. “at least one strain”, unless specified otherwise.

When referring to a compound of which several isomers exist (e.g. a D and an L enantiomer), the compound in principle includes all enantiomers, diastereomers and cis/trans isomers of that compound that may be used in the particular aspect of the invention; in particular when referring to such as compound, it includes the natural isomer(s).

Unless explicitly indicated otherwise, the various embodiments of the invention described herein can be cross-combined.

The term “milk” is intended to encompass milks from mammals and plant sources or mixtures thereof. Preferably, the milk is from a mammal source. Mammals sources of milk include, but are not limited to cow, sheep, goat, buffalo, camel, llama, horse or reindeer. In an embodiment, the milk is from a mammal selected from the group consisting of cow, sheep, goat, buffalo, camel, llama, horse and deer, and combinations thereof. Plant sources of milk include, but are not limited to, milk extracted from soy bean, pea, peanut, barley, rice, oat, quinoa, almond, cashew, coconut, hazelnut, hemp, sesame seed and sunflower seed. Bovine milk is preferred. In addition, the term “milk” refers to not only whole milk, but also skim milk or any liquid component derived thereof or reconstituted milk.

The term “milk base” or “milk-base” refers to a base composition, comprising milk or milk ingredients, or derived from milk or milk ingredients. The milk base can be used as a raw material for the fermentation to produce a fermented milk product. The milk base may for example comprise or consist of skimmed or non-skimmed milk, or reconstituted milk. Optionally the milk base may be concentrated or in the form of powder, or may be reconstituted from such. By reconstituted milk is herein understood liquid milk obtained by adding liquid, such as water, to a skim milk powder, skim milk concentrate, whole milk powder or whole milk concentrate. Furthermore, the milk base may or may not have been subjected to a thermal processing operation which is at least as efficient as pasteurization. Preferably the milk base is from a bovine source.

As used in this specification, the terms “fermented milk product” and “fermented dairy product” are used interchangeably and are intended to refer to products which are obtained by the multiplication of lactic acid bacteria in a milk base leading to a milk coagulum. The particular characteristics of the various fermented milk products depend upon various factors, such as the composition of milk base, the incubation temperature, the composition of the lactic acid bacteria and/or presence of further non-lactic acid microorganisms. Thus, fermented milk products manufactured herein include, for instance, various types of yogurt (including for example set yogurt, low fat yogurt, non-fat yogurt), kefir, dahi, ymer, buttermilk, butterfat, sour cream and sour whipped cream as well as fresh cheeses such as quark and cottage cheese. Petit Suisse or Mozarella is yet another example of a fermented dairy product. Preferably the fermented milk product is not a cheese. Preferably the fermented milk product is a yogurt.

Two basic types of yogurt exist, according to its physical state in the retail container: set yogurt and stirred yogurt. Set yogurt is fermented after being packed in a retail container, and stirred yogurt is almost fully fermented in a fermentation tank before it is packed, the yogurt gel being broken up during the stirring. The fermented milk product produced in the current invention can be a stirred yogurt or a set yogurt. Preferably the fermented milk product is a set yogurt.

The terms “yogurt” and “yoghurt” are used interchangeably herein. The term “yogurt” preferably refers to products comprising or obtained by means of lactic acid bacteria that include at least Streptococcus salivarius thermophilus and Lactobacillus delbruekii subsp. bulgaricus, but may also, optionally, include further microorganisms such as Lactobacillus delbruekii subsp. lactis, Bifidobacterium animalis subsp. lactis, Lactococcus lactis, Lactobacillus acidophilus and Lactobacillus casei, or any microorganism derived therefrom. Such lactic acid strains other than Streptococcus salivarius thermophilus and Lactobacillus delbruekii subsp. bulgaricus, can give the finished product various properties, such as the property of promoting the equilibrium of the gut microbiota. As used herein, the term “yogurt” encompasses set yogurt, stirred yogurt, drinking yogurt, heat treated yogurt and yogurt-like products. More preferably, the term “yogurt” encompasses, but is not limited to, yogurt as defined according to French and European regulations, e.g. coagulated dairy products obtained by lactic acid fermentation by means of specific thermophilic lactic acid bacteria only (i.e. Lactobacillus delbruekii subsp. bulgaricus and Streptococcus salivarius thermophilus) which are cultured simultaneously and are found to be live in the final product in an amount of at least 10 million CFU (colony-forming unit)/g. Preferably, the yogurt is not heat-treated after fermentation. Yogurts may optionally contain added dairy raw materials (e.g. cream) or other ingredients such as sugar or sweetening agents, one or more flavouring(s), fruit, cereals, or nutritional substances, especially vitamins, minerals and fibers. Such yogurt advantageously meets the specifications for fermented milks and yogurts of the AFNOR NF 04-600 standard and/or the codex StanA-IIa-1975 standard. In order to satisfy the AFNOR NF 04-600 standard, the product must not have been heated after fermentation and the dairy raw materials must represent a minimum of 70% (m/m) of the finished product.

The term “starter” or “starter culture” as used herein refers to a culture of one or more food-grade micro-organisms, more preferably a culture comprising lactic acid bacteria, which are responsible for the acidification of the milk base. Starter cultures may be fresh (liquid), frozen or freeze-dried. Freeze dried cultures need to be regenerated before use. For the production of a yogurt, the starter culture (i.e. the total weight of all lactic acid bacterial combined) is preferably added in an amount from 0.001 to 10% by weight, suitably in an amount of 0.01 to 3% by weight, of the total amount of milk base.

As used herein, the term “lactic acid bacteria”, “LAB”, “lactic acid bacterial strains” and “lactic bacteria” are used interchangeably and refer to food-grade bacteria producing lactic acid as the major metabolic end-product of carbohydrate fermentation. These bacteria are related by their common metabolic and physiological characteristics and are usually Gram positive, low-GC, acid tolerant, non-sporulating, non-respiring, rod-shaped bacilli or cocci. During the fermentation stage, the consumption of lactose by these bacteria causes the formation of lactic acid, reducing the pH and leading to the formation of a protein coagulum. These bacteria are thus responsible for the acidification of milk and for the texture of the dairy product. As used herein, the term “lactic acid bacteria” or “lactic bacteria” encompasses, but is not limited to, bacteria belonging to the genus of Lactobacillus spp., Bifidobacterium spp., Streptococcus spp., Lactococcus spp., such as Lactobacillus delbruekii subsp. bulgaricus, Streptococcus salivarius thermophilus, Lactobacillus lactis, Bifidobacterium animalis, Lactococcus lactis, Lactobacillus casei, Lactobacillus plantarum, helveticus, Lactobacillus acidophilus and Bifidobacterium breve.

The terms “polypeptide having chymosin activity”, “chymosin enzyme” and “chymosin” are used interchangeably herein. As used herein the term “chymosin” refers to an aspartic protease, group 3.4.23.4 according to the Enzyme Nomenclature, 1992 of the International Union of Biochemistry and Molecular Biology, IUBMB.

Herein, the term “IMCU” is understood to refer to International Milk Clotting Units. One IMCU equals about 0.126 nmol of bovine chymosin B. The strength of a milk clotting enzyme (such as chymosin enzyme present in a composition of the present invention) is determined as the milk clotting activity (IMCU per ml or per gram). Following the addition of diluted coagulant to a standard milk substrate, the milk will flocculate. The milk clotting time is the time period from addition of the coagulant until formation of visible flocks or flakes in the milk substrate. The strength of a coagulant sample is found by comparing the milk clotting time for the sample to that of a reference standard, a normal. This is expressed in IDF standard 157A: 1997 which gives the IMCU definition: The total milk-clotting activity of the first batch of calf chymosin reference standard powder has once and for all been set at 1000 International Milk-Clotting Units per gram (IMCU/g). Further preparations of reference standards will be set relative to the previous reference. IMCU principle: Determination of the time needed for visible flocculation of renneted standard milk substrate with 0.05% calcium chloride, pH6.5. IMCU/ml of a sample is determined by comparison of the clotting time to that of a standard having known milk clotting activity and having the same enzyme composition of the sample.

### The Stabilizer

The stabilizer used in the aspects of the invention can be any stabilizer known by one skilled in the art to be suitable to stabilize the ingredients in a fermented milk product, preferably a yogurt.

The stabilizer may be derived from a mammal source or from a plant source. An example of a stabilizer derived from a mammal source is gelatin. Preferably the stabilizer is derived from a plant-source. Such a stabilizer derived from a plant-source is sometimes also referred to as a “vegan stabilizer” or “vegetable stabilizer”.

Preferred stabilizers include compounds chosen from a first group consisting of agar, alginate, alginic acid, betaglucan, carrageenan, chitin, chitosan, gelatin, gellan gum, guar gum, gum arabic, gum tragacanth, konjac gum, locust bean gum, pectate, pectin, pectinate, propylene glycol-alginate, scleroglucan, xanthan gum, microcrystalline cellulose, hydroxypropyl cellulose, hydroxypropyl methylcellulose, hydroxyethyl cellulose, carboxymethyl cellulose, methylcellulose, ethylcellulose, starch, carboxymethyl starch, hydrophobically modified starch, and combinations thereof. Most preferred stabilizers include polysaccharides, such as gellan gum, starch, pectin, pectinate, pectate, carboxymethyl starch, modified starch, agar and combinations hereof.

In addition, or in the alternative, the stabilizer may advantageously comprise emulsifier-like compounds. Preferably, the stabilizer thus in addition or in the alternative includes compounds chosen from a second group consisting of mono-, di-, or triglycerides of fatty acids, lactic acid esters of mono- and diglycerides, diacetyl tartaric acid esters of mono- and diglycerides, polyglycerol esters of fatty acid, sodium stearolyl lactylate, hexaglyceryl distearate, lecithin, hydroxylated lecithin, a polyoxyethylene ether of fatty esters of polyhydric alcohols (i.e., a polysorbate, such as polysorbate 80), sucrose esters, and combinations thereof.

Preferred are stabilizers comprising at least one traditional stabilizer compound, preferably chosen from the first group, and at least one emulsifier-like compound, preferably chosen from the second group. Thus, preferably the stabilizer comprises:
one or more compounds chosen from a first group consisting of agar, alginate, alginic acid, betaglucan, carrageenan, chitin, chitosan, gelatin, gellan gum, guar gum, gum arabic, gum tragacanth, konjac gum, locust bean gum, pectate, pectin, pectinate, propylene glycol-alginate, scleroglucan, xanthan gum, microcrystalline cellulose, hydroxypropyl cellulose, hydroxypropyl methylcellulose, hydroxyethyl cellulose, carboxymethyl cellulose, methylcellulose, ethylcellulose, starch, carboxymethyl starch, hydrophobically modified starch, and combinations thereof; and
one or more compounds chosen from a second group consisting of mono-, di-, or triglycerides of fatty acids, lactic acid esters of mono- and diglycerides, diacetyl tartaric acid esters of mono- and diglycerides, polyglycerol esters of fatty acid, sodium stearolyl lactylate, hexaglyceryl distearate, lecithin, hydroxylated lecithin, a polyoxyethylene ether of fatty esters of polyhydric alcohols (i.e., a polysorbate, such as polysorbate 80), sucrose esters, and combinations thereof.

More preferably the stabilizer is a blend of two, three, four, five, six or more compounds. Such a stabilizer blend preferably comprises at least:
starch, carboxymethyl starch or modified starch;
pectin, pectate or pectinate; and
a polysaccharide.

A preferred stabilizer blend is a stabilizer blend comprising modified starch, gellan gum, pectin, agar and DATEM (i.e. DATEM is an abbreviation for Diacetyl Tartaric Acid Esters of Mono & Diglycerides).

Another preferred stabilizer blend is a stabilizer blend comprising starch, pectin, citrus fiber and soybean polysaccharide.

A special type of stabilizer is citrus fiber. Citrus fiber has a high degree of customer acceptability. Stabilizers comprising or consisting of citrus fiber are therefore especially preferred.

Without wishing to be bound by any kind of theory it is believed that the stabilizers have an advantageous effect within the fermented milk products by stabilizing, emulsifying and/or keeping in solution of the dairy ingredients in the fermented milk product, for example through the binding of water.

Preferably the stabilizer or stabilzer blend is added to the milk-base in an amount in the range from equal to or more than 0.005 wt %, more preferably from equal to or more than 0.010 wt %, even more preferably from equal to or more than 0.05 wt %, still more preferably from equal to or more than 0.10 wt %, and most preferably from equal to or more than 0.15 wt % or even from equal to or more than 1.00 wt %, more preferably to equal to or less than 15.00 wt %, even more preferably equal to or less than 10.00 wt %, still more preferably equal to or less than 7.50 wt % and most preferably equal to or less than 5.00 wt %, calculated on the basis of the total weight of the milk-base. Most preferably the stabilizer or stabilzer blend is present within the fermented milk product, preferably a yogurt, in an amount in the range from equal to or more than 0.15 wt % to equal to or less than 5.00 wt %, calculated on the basis of the total weight of the milk-base (i.e. based on the total weight of the milk base, including any supplemented sugars or enzymes contained therein).

### The Lactic Acid Bacterial Strains

The lactic acid bacterial strains used in the aspects of the invention can be any lactic acid strains known by one skilled in the art to be suitable for the preparation of a fermented milk product, preferably a yogurt.

Preferably the lactic acid bacterial strain(s) is/are selected from the group consisting of Lactobacillus spp., Bifidobacterium spp., Streptococcus spp., Lactococcus spp. Leuconostoc spp., Pediococcus spp., Propionobacterium spp., Arthrobacter spp., Corynebacterium spp. and combinations thereof. More preferably the lactic acid bacterial strain(s) comprise or consist of Lactobacillus spp., Bifidobacterium spp., Streptococcus spp., Lactococcus spp, and/or Leuconostoc spp.

Examples of lactic acid bacterial strains include Lactobacillus delbrueckii, Lactobacillus delbrueckii subsp. bulgaricus Lactobacillus acidophilus, Lactobacillus caseii, Lactobacillus ssp., Lactobacillus helveticus, Lactobacillus crispatus, Lactobacillus amylovorus, Lactobacillus plantarum, Lactobacillus sanfrancisco, Lactobacillus pontis, Lactobacillus bavaricus, Lactobacillus curvatus, Lactobacillus sacei, Leuconostoc mesenteroides, Leuconoctoc lactis, Leuconostoc ssp., Pediococcus pentosaveus, Pediococcus avidilactici, Staphylococcus xylosus, Propionibacterium freudenreichii, Propionibacterium freudenreichii subsp. shermanii, Streptococcus thermophilus.

More preferably, the lactic acid bacterial strain(s) is/are selected from the group consisting of Lactobacillus delbruekii subsp. bulgaricus, Streptococcus (salivarius) thermophilus, Lactobacillus lactis, Bifidobacterium animalis, Lactococcus lactis, Lactobacillus casei, Lactobacillus plantarum, Lactobacillus helveticus, Lactobacillus acidophilus, Bifidobacterium breve and/or combinations thereof.

Most preferably the lactic acid bacterial strains comprise or consist of Lactobacillus delbruekii subsp. bulgaricus and Streptococcus thermophilus.

Preferably the milk base is fermented in the presence of a starter culture comprising at least:
a Streptococcus thermophilus strain; and
a Lactobacillus delbrueckii subsp. bulgaricus stain.

The starter culture can comprise lactic acid bacterial strains consisting of only a Streptococcus thermophilus strain and a Lactobacillus delbrueckii subsp. bulgaricus stain. That is, suitably the milk base can be fermented in the presence of a Streptococcus thermophilus strain and a Lactobacillus delbrueckii subsp. bulgaricus strain as the sole lactic acid bacterial strains. However, more preferably the starter culture comprises lactic acid bacterial strains that include a Streptococcus thermophilus strain and a Lactobacillus delbrueckii subsp. bulgaricus stain and in addition one or more further lactic acid bacterial strain(s). That is, suitably the milk base can be fermented in the presence of a Streptococcus thermophilus strain and a Lactobacillus delbrueckii subsp. bulgaricus stain and one or more further lactic acid bacterial strain(s). For example, the milk base can be fermented in the presence of a strain of Streptococcus thermophilus, a strain of Lactobacillus delbrueckii spp. bulgaricus and in addition a strain of Lactobacillus acidophilus Lactobacillus helveticus, Bifidobacterium animalis, Bifidobacterium breve and/or a strain of Lactococcus lactis spp. lactis.

Preferably, the starter culture comprises a content of viable lactic acid bacterial cells for each of the desired lactic acid bacterial strains of at least 1×10⁷ colony forming units (cfu) per gram (g) starter culture, more preferably at least 1×10⁸ cfu/g, more preferably at least 1×10⁹ cfu/g, even more preferably at least 1×10¹⁰ cfu/g, still more preferably at least 1×10¹¹ cfu/g, yet even more preferably at least 1×10¹² cfu/g and most preferably at least 1×10¹³ cfu/g starter culture. The advantage of such high concentrations of lactic acid bacteria in the starter culture is that small amounts of starter culture are sufficient for the inoculation of large amounts of milk base.

The total amount of lactic acid bacterial stains added to the milk base preferably lies in the range from equal to or more than 0.001% (w/w), more preferably equal to or more than 0.005% (w/w), even more preferably equal to or more than 0.01% w/w, still more preferably equal to or more than 0.05% (w/w) and most preferably equal to or more than 0.1% (w/w) to equal to or less than 10.0% (w/w), more preferably equal to or less than 5.0% w/w, even more preferably equal to or less than 3.0% (w/w), still more preferably equal to or less than 1.0% (w/w) and most preferably equal to or less than 0.5% (w/w), based on the total weight of the milk-base (i.e. based on the total weight of the milk base, including any supplemented sugars or enzymes contained therein).

Suitable starter cultures comprising suitable lactic acid bacterial strains for the aspects of the invention can be commercially obtained under the brands CESKA® STAR, DELVO® FRESH and BIOGHURT® from DSM Food & Beverages in the Netherlands and/or under the brand YOFLEX® from Chr. Hansen in Denmark.

In a further preferred embodiment, the lactic acid bacteria (LAB) strains include one or more lactose-deficient lactic acid bacteria strains, preferably one or more lactose-deficient Streptococcus thermophilus strains and/or one or more Lactobacillus delbrueckii subsp. bulgaricus stains. By the term “lactose deficient” is herewith understood LAB which either partially or completely lost the ability to use lactose as a source for cell growth or maintaining cell viability. Preferably such lactose-deficient lactic acid bacteria are capable of metabolizing one or several carbohydrates selected from sucrose, galactose and/or glucose or another fermentable carbohydrate that is not lactose. These other carbohydrates can be added to the milk base in desired amounts to support fermentation by lactose deficient lactic acid bacteria strains. Starter cultures comprising such lactose deficient lactic acid bacteria strains can be commercially obtained under the brand SWEETY® from Chr. Hansen in Denmark.

### The Coagulant

The coagulant in the aspects of the invention can comprise or consists of one or more “rennet enzymes”. By a “rennet enzyme” is herein preferably understood an enzyme that occurs in rennet. Rennet is a natural coagulant produced by mammals, such as cows and camels, that comprises a mixture of enzymes that works to coagulate milk.

Preferably the coagulant in the aspects of the invention comprises or consists of chymosin. The terms “polypeptide having chymosin activity”, “chymosin enzyme” and “chymosin” are used interchangeably herein. The chymosin enzyme is preferably an aspartic protease, preferably an aspartic endopeptidase, group 3.4.23.4 according to the Enzyme Nomenclature, 1992 of the International Union of Biochemistry and Molecular Biology, IUBMB.

Chymosin is naturally produced by gastric chief cells in juvenile mammals. The chymosin can therefore be a so-called “natural chymosin” or “mammal chymosin”, derived from a mammal, such as bovine chymosin or camel chymosin.

Preferably the coagulant is a microbial coagulant. Such a microbial coagulant may advantageously be produced by micro-organisms, such as for example bacteria, yeasts or fungi, such as for example Rhizomucor miehei. Preferably the coagulant comprises or consists of chymosin and the chymosin is a microbial chymosin. A microbial coagulant, respectively a microbial chymosin, has the advantage that it is more acceptable to customers having a vegan or other diet.

Preferably the chymosin is a polypeptide having chymosin activity that is capable of hydrolysing bovine casein. More preferably the chymosin is a polypeptide having chymosin activity that is capable of hydrolysing bovine alpha s1-casein at position F23F24 so as to form αs1-I CN (f24-199) more rapidly than camel chymosin.

Preferred coagulants include those described in patent publications WO2007/118838 and EP2333056 and these are incorporated herein by reference. Preferably the coagulant comprises or consists of chymosin enzyme. Preferred chymosin enzymes include those described in patent publications EP3143879, EP2844750, EP2844751, WO1995/29999, WO2013/164481, WO2013/164479, WO2015/128417, and WO2008/098973 and these are incorporated herein by reference.

Suitable coagulants for the aspects of the invention can be obtained under the brand FROMASER from DSM Food & Beverages in the Netherlands and/or under the brands HANNILASER and/or MICROLANT® from Chr. Hansen in Denmark. Suitable chymosin enzymes for the aspects of the invention can be commercially obtained under the brand MAXIREN® from DSM Food & Beverages in the Netherlands and/or under the brand CHY-MAX® from Chr. Hansen in Denmark.

Preferably the milk-base is inoculated with an amount of coagulant, preferably chymosin enzyme, in the range from equal to or more than 30 IMCU/gram, more preferably from equal to or more than 50 IMCU/gram, even more preferably from equal to or more than 100 IMCU/gram, and most preferably from equal to or more than 200 IMCU/gram, to equal to or less than 5000 IMCU/gram, more preferably to equal to or less than 4000 IMCU/gram, even more preferably to equal to or less than 3000 IMCU/gram and most preferably to equal to or less than 2000 IMCU/gram. Most preferably the milk-base is inoculated with an amount of coagulant, preferably chymosin enzyme, in the range from equal to or more than 200 IMCU/gram to equal to or less than 2000 IMCU/gram.

Preferably the coagulant, preferably a chymosin enzyme, is further applied in an amount of from equal to or more than 10 mg/L (milligram per liter milk-base), more preferably from equal to or more than 15 mg/L, more preferably from equal to or more than 30 mg/L, and most preferably from equal to or more than 100 mg/L, to equal to or less than 2000 mg/L, more preferably to equal to or less than 1000 mg/L.

### The Kit of Parts

In one of the aspects of the invention a kit of parts is provided comprising or consisting of:
one or more lactic acid bacterial strains;
a coagulant, preferably a polypeptide having chymosin activity; and
optionally, a stabilizer.

Preferences for the one or more lactic acid bacterial strains, the coagulant and the stabilizer are as described above. The one or more lactic acid bacterial strains, the coagulant and the stabilizer can be added to the milk base each separately or together. More preferably the one or more lactic acid bacterial strains, the coagulant and optionally the stabilizer are combined in one kit of parts. This kit of parts can advantageously be contacted “in one go” with the milk base. This advantageously allows for simultaneous contacting of the one or more lactic acid bacterial strains, the coagulant and optionally the stabilizer with the milk base.

More preferably kit of parts comprises:
one or more lactic acid bacterial strains, preferably including a Streptococcus thermophilus strain and a Lactobacillus delbrueckii subsp. bulgaricus stain; and
a coagulant, preferably a polypeptide having chymosin activity; and
optionally, a stabilizer, such as agar, citrus fiber or a stabilizer blend; and
one or more other compounds.

Preferably the kit of parts comprises the one or more lactic acid bacterial strains and/or the coagulant and/or the stabilizer in the form of separate frozen or freeze-dried pellets.

The invention therefore also provides a kit of parts comprising:
frozen or freeze-dried pellets comprising one or more lactic acid bacterial strains, preferably including a Streptococcus thermophilus strain and a Lactobacillus delbrueckii subsp. bulgaricus stain;
frozen or freeze-dried pellets comprising a coagulant, preferably a polypeptide having chymosin activity; and/or
frozen or freeze-dried pellets comprising a stabilizer.
   The kit of parts can conveniently be provided in a package, for example with a package size in the range from equal to or more than 1 grams to equal to or less than 1000 kilograms, more preferably in the range from equal to or more than 1 kilograms to equal to or less than 100 kilograms.

Preferably the above kit of parts comprises a total weight of one or more lactic acid bacterial strains in the range from equal to or more than 20.0% by weight (w/w), more preferably equal to or more than 40.0% (w/w), even more preferably equal to or more than 50.0% (w/w) and still more preferably equal to or more than 70.0% (w/w) or even equal to or more than 90.0% (w/w) or equal to or more than 95.0% (w/w) to equal to or less than 99.9% (w/w), more preferably equal to or less than 99% (w/w) and possibly equal to or less than 95% (w/w) or even equal to or less than 90% (w/w), based on the total weight of the kit of parts.

Preferably the kit of part comprises a total weight of coagulant in the range from equal to or more than 0.01% by weight (w/w), more preferably equal to or more than 0.05% (w/w), even more preferably equal to or more than 0.1% (w/w) and still more preferably equal to or more than 0.5% (w/w) or even equal to or more than 1.0% (w/w) or equal to or more than 2.0% (w/w) to equal to or less than 30% (w/w), more preferably equal to or less than 20% (w/w) and possibly equal to or less than 10% (w/w) or even equal to or less than 8% (w/w), based on the total weight of the kit of parts.

The kit of parts can optionally also comprise the stabilizer.

Preferably the kit of parts includes one or more compounds or materials in addition to the lactic acid bacterial strains and the coagulant, such as for example fillers, excipients or protectants, such as cryoprotectants and/or lyoprotectants. These compounds or materials can be added to ensure or increase the stability of the lactic acid bacterial strain(s) or the coagulant(s), for example during long term storage or that are added to improve disability or flowability. Cryoprotectants and/or lyoprotectants can be used to protect the lactic acid bacteria and/or the coagulant from damage during freezing and thawing, respectively during freeze-drying. Such a cryoprotectant, respectively lyoprotectant, may be any additive as long as it protects the lactic acid bacterial cells or the enzyme from damage during freezing and thawing, respectively freeze-drying.

Suitable excipients and/or protectants include proteins, carbohydrates including monosaccharides (e.g. galactose, glucose, fructose, D-mannose, sorbose), disaccharides (e.g. lactose, trehalose, sucrose), polysaccharides (e.g. raffinose, starch, gums, celluloses, maltodextrin, cyclodextrin, dextran), polyalcohols (e.g. glycerol, sorbitol, mannitol), polyethers (e.g. polypropylene glycol, polyethylene glycol, polybutylene glycol), antioxidants (e.g. natural antioxidants such as ascorbic acid, beta-carotene, vitamin E, glutathione, chemical antioxidants), oils (e.g. rapeseed oil, sunflower oil, olive oil), surfactants (e.g. Tween®20, Tween®80, fatty acids), peptones (e.g. soy peptones, wheat peptone, whey peptone), tryptones, vitamins, minerals (e.g. iron, manganese, zinc), hydrolysates (e.g. protein hydrolysates such as whey powder, malt extract, soy), amino acids (e.g. monosodium glutamate, glycine, alanine, arginine, histidine), nucleobases (e.g. cytosine, guanine, adenine, thymine, uracil, xanthine, hypoxanthine, inosine), yeast extracts (e.g. yeast extracts of Saccharomyces spp., Kluyvermomycesa spp., or Torula spp.), beef extract, growth factors, and lipids and combinations of all of these.

Preferably the kit of parts comprises a non-reducing, disaccharide, oligosaccharide or polysaccharide, most preferably sucrose. Preferably the milk-base is contacted with a disaccharide, preferably sucrose, and the disaccharide, preferably sucrose, is present in a concentration of at least 5% wt/wt, based on the total weight of milk-base.

Most preferably the kit of parts comprises:
one or more lactic acid bacterial strains, preferably including a Streptococcus thermophilus strain and a Lactobacillus delbrueckii subsp. bulgaricus stain; and
a coagulant, preferably a polypeptide having chymosin activity; and
optionally, a stabilizer, such as agar, citrus fiber or a stabilizer blend; and
sucrose.

Preferably, the one or more lactic acid bacterial strains are present in the form of a starter culture as described herein before. Preferably the weight ratio of coagulant to lactic acid bacteria, in the kit of parts and/or during fermentation, lies in the range from equal to or more than 0.001:1, preferably equal to or more than 0.01:1 to equal to or less than 1:1, more preferably equal to or less than 0.1:1.

As explained above, preferably the kit of parts can be added to the milk base. The kit of parts therefore may or may not comprise any milk base itself. More preferably the kit of parts does not comprise a milk base and/or milk ingredients. Most preferably the kit of parts does not comprise lactose.

### Fermenting

In one of the aspects of the invention there is provided a process for the production of a fermented milk product, preferably a yogurt, comprising the steps of:
(a) fermenting the milk-base with one or more lactic acid bacterial strains, a coagulant and a stabilizer to generate a fermented milk product; and
(b) heat treating the fermented milk product at a temperature of at least 70° C. for a period of at least 5 seconds to generate a heat-treated fermented milk product.

In step (a) the milk base is suitably fermented with the one or more lactic acid bacterial strains and the coagulant in the presence of the stabilizer. During this fermentation, the milk base can be acidified.

That is, the invention also provides the use of a combination of a stabilizer and a coagulant, preferably an enzyme having chymosin activity, for the production of a fermented milk product, preferably a yogurt, more preferably an ambient yogurt.

More preferably the invention provides the use of a starter culture, comprising a combination of one or more lactic acid bacterial strains as described herein before, and a stabilizer and a coagulant, preferably an enzyme having chymosin activity, for the purpose of acidification and/or fermentation of a milk base. That is, preferably the invention provides the use of a starter culture, comprising a combination of one or more lactic acid bacterial strains as described herein before, and a stabilizer and a coagulant, preferably an enzyme having chymosin activity, for the production of a fermented milk product, preferably a yogurt, more preferably an ambient yogurt.

The process conditions during such acidification, respectively fermentation, can be varied widely.

The milk base may be adjusted to arrange for the desired amounts of fat and/or proteins. If so desired, stabilizers and/or other additives may be added. It is especially preferred to add a non-reducing, disaccharide, oligosaccharide or polysaccharide, most preferably sucrose, to the milk base.

Before step (a) the milk base is preferably heated and cooled again. That is, preferably the milk base is heated and cooled again before addition of the one or more lactic acid bacterial strains and/or the coagulant. Such a heating step preferably precedes the fermentation step (a) and can also be referred to as a first pasteurization step. In such a first heat-treatment step, respectively first pasteurization step, preceding step (a), the milk base is preferably heat treated at a temperature of at least 70° C. for a period of at least 5 seconds. More preferably the milk base is heated-treated at a temperature equal to or more than 70° C., more preferably a temperature equal to or more than 75° C., even more preferably a temperature equal to or more than 80° C., still more preferably a temperature equal to or more than 85° C., for a period of preferably equal to or more than 30 seconds, more preferably equal to or more than 5 minutes, even more preferably equal to or more than 10 minutes, still more preferably equal to or more than 20 minutes and most preferably equal to or more than 30 minutes. In the alternative or in addition, the milk base may be heated at a temperature of equal to or more than 90° C., preferably equal to or more than 95° C., preferably for a period of equal to or more than 10 minutes. The heat treatments advantageously allow for the elimination of pathogens. In addition, the heat treatments can help to create a better environment for the lactic acid bacterial cells to grow. After the heat-treatment step, respectively pasteurization step, the milk base is cooled again. Thus, when optionally applying such a first heat-treatment step, respectively first pasteurization step, the milk base is cooled again before carrying out step (a). That is, before adding the one or more lactic acid bacterial strains and/or the coagulant, the milk-base is cooled again. Cooling can for example be carried out by an ice-bath.

Optionally the milk base can be homogenized (e.g. stirred or mixed) before fermentation. Without wishing to be bound by any kind of theory, such homogenization may allow for an improved consistency of the fermented milk product.

After the optional heating and before inoculation of the milk base with the lactic acid bacterial strain(s), the milk base is preferably cooled to the desired fermentation temperature. More preferably, before starting step (a), the temperature of the milk base is adjusted to a fermentation temperature in the range from equal to or more than 18° C., preferably equal to or more than 22° C. to equal to or less than 45° C., more preferably equal to or less than 42° C. Most preferably fermentation step (a) is carried out at a temperature in the range from equal to or more than 18° C., preferably equal to or more than 22° C. to equal to or less than 45° C., more preferably equal to or less than 42° C.

Fermentation of the milk base can suitably be carried out in a so-called fermentation vat or fermentation tank.

The milk base can be inoculated with the one or more lactic acid bacterial strains and/or the coagulant, preferably chymosin enzyme, in any manner known by the person skilled in the art. For example, the one or more lactic acid bacterial strains and/or the coagulant, preferably chymosin enzyme, can be dosed batchwise, semi-batchwise or continuously, including for example by inline dosing.

Although the temperature can be adjusted during fermentation, the temperature during fermentation is preferably kept constant. Preferably a constant fermentation temperature is chosen in the range from equal to or more than 18° C., preferably equal to or more than 22° C. to equal to or less than 45° C., more preferably equal to or less than 42° C. During the fermentation the pH decreases. Preferably the fermentation is continued until a certain desired pH, preferably a pH in the range from equal to or more than pH 4.0 to equal to or less than pH 4.8, is reached. More preferably the fermentation is at least continued for a certain period of time until a pH of for example pH 4.8, pH 4.7, pH 4.6, pH 4.5, pH 4.4, pH 4.3, pH 4.2, pH 4.1 or pH 4.0 is reached. The time period until the desired pH is reached is herein also referred to as “acidification time”. Preferably the time to reach a pH of for example pH 4.5 is equal to or less than 22 hours, more preferably equal to or less than 16 hours, even more preferably equal to or less than 10 hours and most preferably equal to or less than 7 hours.

When the desired pH is reached, the fermentation can be stopped in any manner known to the person skilled in the art. Preferably the fermentation is stopped by cooling the fermented milk product, for example by reducing the temperature to a temperature equal to or less than 10° C., more preferably equal to or less than 8° C., and most preferably equal to or less than 7° C. The fermented milk product can suitably be removed from the fermentation vat or fermentation tank.

Step (a) is preferably followed by step (b). Step (b) suitably comprises heat treating the fermented milk product at a temperature of at least 70° C. for a period of at least 5 seconds to generate a heat-treated fermented milk product. Such a second heat-treatment step (b) suitably follows the fermentation step (a) and can also be referred to as a second pasteurization step. In such a second heat-treatment step, respectively second pasteurization step, subsequent to step (a), the fermented milk product is preferably heat treated at a temperature of at least 70° C. for a period of at least 5 seconds. More preferably the fermented milk product is heated-treated at a temperature equal to or more than 70° C., more preferably a temperature equal to or more than 75° C., even more preferably a temperature equal to or more than 80° C., still more preferably a temperature equal to or more than 85° C., for a period of preferably equal to or more than 30 seconds, more preferably equal to or more than 5 minutes, even more preferably equal to or more than 10 minutes, still more preferably equal to or more than 20 minutes and most preferably equal to or more than 30 minutes. In the alternative or in addition, the fermented milk product may be heated at a temperature of equal to or more than 90° C., preferably equal to or more than 95° C., preferably for a period of equal to or more than 10 minutes.

After the second heat-treatment step, respectively the second pasteurization step, the fermented heat product is preferably cooled again. Preferably the temperature of the fermented milk product is adjusted to a desired storage temperature in the range from equal to or more than 10° C., more preferably from equal to or more than 15° C., even more preferably from equal to or more than 17° C., still more preferably from equal to or more than 18° C. and most preferably from equal to or more than 20° C. to equal to or less than 40° C., preferably to equal to or less than 35° C., more preferably to equal to or less than 32° C., even more preferably to equal to or less than 30° C., still more preferably to equal to or less than 28° C., and most preferably to equal to or less than 26° C.

Optionally the fermented milk product can be stirred and/or fruit and/or flavors can be added to the fermented milk product. Subsequently the fermented milk product can be packaged as desired.

Preferably the heat-treated fermented milk product is subsequently stored in a step (c) at a temperature in the range from equal to or more than 10° C. to equal to or less than 40° C. Preferably the heat-treated fermented milk product is subsequently stored without refrigeration. Preferably the fermented milk product is stored, preferably without refrigeration, at a temperature in the range from equal to or more than 10° C., more preferably from equal to or more than 15° C., even more preferably from equal to or more than 17° C., still more preferably from equal to or more than 18° C. and most preferably from equal to or more than 20° C. to equal to or less than 40° C., preferably to equal to or less than 35° C., more preferably to equal to or less than 32° C., even more preferably to equal to or less than 30° C., still more preferably to equal to or less than 28° C., and most preferably to equal to or less than 26° C.

### The Fermented Milk Product

The fermented milk products can suitably be a yogurt, kefir, dahi, ymer, buttermilk, butterfat, sour cream or sour whipped cream as well as fresh cheeses such as quark and cottage cheese. Petit Suisse or Mozarella is yet another example of a fermented dairy product. Preferably the fermented milk product is a yogurt, kefir, dahi, ymer, buttermilk, butterfat, sour cream or sour whipped cream. More preferably the fermented milk product is not a cheese. More preferably the fermented milk product is a yogurt. Preferably the yogurt is a drinking yogurt, a stirred yogurt or a set yogurt. An especially preferred yogurt is a drinking yogurt. Another especially preferred yogurt is a set yogurt. Most preferably the yogurt is a Greek style set yogurt.

The fermented milk product, preferably a yogurt, can suitably be a refrigerated fermented milk product or an ambient fermented milk product. Preferably the fermented milk product, more preferably a yogurt, is an ambient fermented milk product, respectively an ambient yogurt.

By an ambient fermented milk product, respectively an ambient yogurt, is herein suitably understood a fermented milk product, respectively a yogurt, that is or can be stored at ambient temperature and that does not require refrigeration. By ambient temperature is herein preferably understood a temperature in the range from equal to or more than 10° C., more preferably from equal to or more than 15° C., even more preferably from equal to or more than 17° C., still more preferably from equal to or more than 18° C. and most preferably from equal to or more than 20° C. to equal to or less than 40° C., preferably to equal to or less than 35° C., more preferably to equal to or less than 32° C., even more preferably to equal to or less than 30° C., still more preferably to equal to or less than 28° C., and most preferably to equal to or less than 26° C. The temperatures can conveniently be determined at a pressure of 1 bar. Most preferably ambient temperature is herein understood as a temperature in the range from equal to or more than 18° C. to equal to or less than 28° C.

Hence, preferably the fermented milk product, preferably a yogurt, is a fermented milk product, preferably a yogurt, that is stored at a temperature in the range from equal to or more than 10° C., more preferably from equal to or more than 15° C., even more preferably from equal to or more than 17° C., still more preferably from equal to or more than 18° C. and most preferably from equal to or more than 20° C. to equal to or less than 40° C., preferably to equal to or less than 35° C., more preferably to equal to or less than 32° C., even more preferably to equal to or less than 30° C., still more preferably to equal to or less than 28° C., and most preferably to equal to or less than 26° C. Most preferably the fermented milk product, preferably a yogurt, is a fermented milk product, preferably a yogurt, that is stored at a temperature in the range from equal to or more than 18° C. to equal to or less than 28° C.

As explained above, ambient fermented milk products, such as ambient yogurt, can be produced by subjecting the fermented milk product, respectively the yogurt, after fermentation to a heat treatment. Preferences for the heat treatment are the same as provided above in the description of the process. The heat treatment is directed at killing undesired microbes present in the fermented milk products, respectively the yogurt. As a consequence of the heat treatment also the lactic acid bacteria and optionally the chymosin aree deactivated and/or destroyed.

The invention thus also provides a fermented milk product, preferably a yogurt, obtained or obtainable by the process described above. That is, suitably the invention also provides a fermented milk product, preferably a yogurt, comprising: (i) one or more inactivated lactic acid bacterial strains; (ii) one or more inactivated coagulants; and (iii) a stabilizer.

Preferences for the lactic acid bacterial strains, the coagulant, the polypeptide having chymosin activity and the stabilizer are as mentioned herein above. The fermented milk product, preferably a yogurt, is preferably stable for at least 3 days, more preferably at least 5 days, even more preferably for at least 10 days, still more preferably for at least 14 days, yet more preferably for at least 1 month, still yet more preferably for at least 2 months during storage at a temperature in the range from equal to or more than 10° C., more preferably from equal to or more than 15° C., even more preferably from equal to or more than 17° C., still more preferably from equal to or more than 18° C. and most preferably from equal to or more than 20° C. to equal to or less than 40° C., preferably to equal to or less than 35° C., more preferably to equal to or less than 32° C., even more preferably to equal to or less than 30° C., still more preferably to equal to or less than 28° C., and most preferably to equal to or less than 26° C.

Hereinbelow the invention is illustrated by a number of following non-limiting examples.

### EXAMPLES

### Examples 1 to 19

### Preparation of the Milk-Base Substrate

In examples 1 to 19, a fresh whole milk was obtained from the market, containing 3.2 wt % total protein and 3.8 wt % total fat, based on the fresh whole milk. As indicated in Table 1, in most of the recipes used in the examples, stabilizer and sucrose were added. As a result thereof the weight percentage of protein in the milk decreased. Therefore whey protein was added in amounts as appropriate, as listed in Table 1, to standardize the ready-to-ferment milk-base substrate, ensuring the protein levels in the ready-to-ferment milk-base substrates for all examples 1 to 19 were kept at 3.1 wt %.

Thus, in all examples 1 to 19, a fresh whole milk obtained from the market, containing 3.2 wt % total protein and 3.8 wt % total fat, based on the fresh whole milk, was standardized with the addition of whey protein concentrate as indicated in Table 1 to prepare a ready-to-ferment milk-base substrate comprising 3.1 wt % protein and 3.3 wt % fat, based on the total weight of the milk-base substrate (i.e. including also the stabilizer and other ingredients as listed below) of 100 wt %.

Standardization was carried out by heating the fresh whole milk to 50-55° C. using a laboratory stirrer and an electromagnetic oven. The required amount of whey proteins as listed in Table 1 was added to the milk gradually and the milk was stirred with a stirrer bar continuously at 250 rpm for 30 min.

### Addition of the Stabilizers and Sugar

To the mixture of whole fresh milk and whey protein, stabilizer and a sugar (sucrose) were added, both in the needed amounts as indicated in Table 1, to prepare the ready-to-ferment milk-base substrate.

In examples 1 to 8, Stabilizer 1 (ST1) was used.
Stabilizer 1 (ST1) was a stabilizer blend comprising modified starch, gellan gum, pectin, agar and DATEM (i.e. DATEM is an abbreviation for Diacetyl Tartaric Acid Esters of Mono & Diglycerides). Stabilizer 1 (ST1) is commercially obtainable as DGE213-1 from DSM Food & Beverages, Alexander Fleminglaan 1, Delft, the Netherlands. In examples 1 to 8, Stabilizer 1 (ST1) and the sucrose were added in the needed amounts as indicated in Table 1 in the milk-base at 60-65° C. and then stirred at 250 rpm for 20 min to guarantee a good dissolution.

In examples 9 and 10, Stabilizer 2 (ST2) was used.
Stabilizer 2 (ST2) was a stabilizer blend comprising starch, pectin, citrus fiber and soybean polysaccharide. Stabilizer 2 (ST2) is commercially obtainable as DGB1121-1 from DSM Food & Beverages, Alexander Fleminglaan 1, Delft, the Netherlands. In examples 9 and 10, Stabilizer 2 (ST2) and the sucrose were added in the needed amounts as indicated in Table 1 in the milk-base at 60-65° C. and then stirred at 250 rpm for 20 min to guarantee a good dissolution.

In comparative examples 11 to 15 no stabilizer was used.
Examples 11 to 15 are comparative examples. Here no stabilizer was used. The whole milk was heat to 50-55° C. using laboratory stirrer and electromagnetic oven. The amount of sucrose as listed in Table 1 was added together with the whey proteins to the milk (as described above), where the mixture was stirred with a stirrer bar continuously at 250 rpm for 30 min.

In examples 16 and 17, agar was used as a stabilizer.
In examples 16 and 17 the agar and the sucrose were added in the needed amounts as indicated in Table 1 in the milk-base at 60-65° C. and then stirred at 250 rpm for 20 min to guarantee a good dissolution.

In examples 18 and 19, citrus fiber was used as a stabilizer.

In examples 18 and 19 the citrus fiber and the sucrose were added in the needed amounts as indicated in Table 1 in the milk-base at 60-65° C. and then stirred at 250 rpm for 20 min to guarantee a good dissolution.

### First Pasteurization

The milk-base substrate, comprising the milk-base and, where appropriate, any stabilizer and/or sucrose as indicated in Table 1, is homogenized and pasteurized for a first time (hereafter referred to as “First Pasteurization”) under the conditions as listed for each example in Table 2. Hereafter the milk-based substrate was cooled to 43° C. in ice water and filled in a fermentation tank at 43° C.

### Fermentation of the Milk-Base in the Presence of the Culture and Chymosin

After the milk-based substrate was cooled to 43° C. in ice water and filled in the fermentation tank at 43° C., the milk-base substrate in the fermentation tank was inoculated with the culture and the chymosin (i.e. the polypeptide having chymosin activity) as needed in the amounts as listed in Table 1. Subsequently the milk-base substrate was fermented at 43° C. until a pH of 4.5 was reached (as indicated in Table 2). Once a pH of 4.5 was reached, the fermentation was stopped by cooling to 15-20° C.

In examples 1 to 8 and examples 11 to 15, Culture 1 (CU1) was used as a culture.
Culture 1 (CU1) is a culture comprising multiple Streptococcus thermophilus bacterial strains and one Lactobacillus bulgaricus strain. It is commercially obtainable as “DELVO® YOG GREEK INDEED|DSL” from DSM Food & Beverages, Alexander Fleminglaan 1, Delft, the Netherlands. The Culture 1 (CU1) was applied in the amount as listed in Table 1.

In examples 9 and 10 and examples 16 to 19, Culture 2 (CU2) was used as a culture.
Culture 2 (CU2) is a culture comprising multiple Streptococcus thermophilus bacterial strains and one Lactobacillus bulgaricus strain. It is commercially obtainable as “HTLP-02” from DSM Food & Beverages, Alexander Fleminglaan 1, Delft, the Netherlands. The Culture 2 (CU2) was applied in the amount as listed in Table 1. The Culture 2 (CU2) was applied in the amount as listed in Table 1

In examples 1 to 5 and 11 to 14, Chymosin 1 (CH1) was used.
Chymosin 1 (CH1) is a polypeptide with chymosin activity commercial obtainable as Maxiren® 1800 granulate from DSM Food & Beverages, Alexander Fleminglaan 1, Delft, the Netherlands. The Chymosin 1 (CH1) was applied in the amount as listed in Table 1. The milk-base substrate was inoculated with the Chymosin 1 (CH1) at 1800 IMCU/g.

In examples 7 and 9 and 16 and 18, Chymosin 2 (CH2) was used.
Chymosin 2 (CH2) is a polypeptide with chymosin activity commercial obtainable as Maxiren® XDS from DSM Food & Beverages, Alexander Fleminglaan 1, Delft, the Netherlands. The Chymosin 2 (CH2) was applied in the amount as listed in Table 1. The milk-base substrate was inoculated with the Chymosin 2 (CH2) at 620 IMCU/g.

In examples 6, 8 and 10 and 15, 17 and 19 no chymosin was used.

### Termination of Fermentation

As indicated above, once a pH of 4.5 was reached, the fermentation was terminated by cooling to 15-20° C. After termination of the fermentation the fermented milk product, in this case a yogurt, was removed from the fermentation tank and stirred at 200 rpm. In example 1 the yoghurt was stirred at 200 rpm during 1 hour. In examples 2 to 19 the yoghurt was stirred at 200 rpm for 3 minutes.

Second Pasteurization after Fermentation

In order to prepare an ambient fermented milk product, that is, a fermented milk product suitable for storage at temperatures in the range from 15 to 35° C., the fermented milk product was subjected to pasteurization for a second time.

In the examples 1 to 8 and 11 to 19, the second pasteurization comprised pasteurizing the freshly prepared yoghurt at 75° C. during 30 seconds by subjecting the yogurt to a hot water bath to reach 75° C. and cooling it down immediately in ice water bath to 20° C.

In the examples 9 and 10, the second pasteurization comprised pasteurizing the freshly prepared yoghurt at 85° C. during 20 minutes.

After the second pasteurization the yogurt was stored at room temperature (about 25° C.) for further analysis.

### Particle Size Method:

The particle size was measured by using a Mastersizer 2000 laser diffraction particle size analyzer. The sample was added in the water until 10-12%. Each sample was retested five times automatically by the apparatus to generate average data. The test temperature was 25° C., the medium was water, and rotation rate was 2000 rpm.

### Viscosity Method (Brookfield Viscometer)

The T-C rotator was lowered down to the surface of the sample. The temperature was 4-8° C. the speed was 100 rpm. The samples were tested for 90 seconds. A total of 18 points was collected, with 5 seconds per point. The average was determined from 30 seconds to 90 seconds.

The LV2 rotator was lowered down to the surface of the sample. The temperature was 25° C. the speed was 100 rpm. The samples were tested for 60 seconds. A total of 18 points was collected, with 5 seconds per point. The average was determined from 30 seconds to 60 seconds.

TABLE 1
Recipe Overview for examples 1 to 19 (all recipes
completed to 100 wt % by addition of water)

| | Whole | Whey | | | | | | | |
|---|---|---|---|---|---|---|---|---|---|
| | fresh milk | protein | Stabilizer | | Sucrose | Culture | | Chymosin | |
| Ex. | (wt %) | (wt %) | (wt %) | | (wt %) | (U/T) | | (mg/L) | |
| 1 | 87 | 0.4 | ST1 | 2.13 | 8 | CU1 | 3 | CH1 | 3.5 |
| 2 | 87 | 0.4 | ST1 | 2.13 | 8 | CU1 | 3 | CH1 | 10.4 |
| 3 | 87 | 0.4 | ST1 | 2.13 | 8 | CU1 | 3 | CH1 | 17.3 |
| 4 | 87 | 0.4 | ST1 | 2.13 | 8 | CU1 | 3 | CH1 | 34.5 |
| 5 | 87 | 0.4 | ST1 | 2.13 | 8 | CU1 | 3 | CH1 | 103.5 |
| 6* | 87 | 0.4 | ST1 | 2.13 | 8 | CU1 | 3 | n.a. | n.a. |
| 7 | 87 | 0.4 | ST1 | 2.13 | 8 | CU1 | 3 | CH2 | 300 |
| 8* | 87 | 0.4 | ST1 | 2.13 | 8 | CU1 | 3 | n.a. | n.a. |
| 9 | 87 | 0.4 | ST2 | 2.6 | 6 | CU2 | 2 | CH2 | 50 |
| 10* | 88 | 0.86 | ST2 | 2.6 | 6 | CU2 | 2 | n.a. | n.a. |
| 11* | 87 | 0.4 | n.a. | n.a. | 8 | CU1 | 3 | CH1 | 3.5 |
| 12* | 87 | 0.4 | n.a. | n.a. | 8 | CU1 | 3 | CH1 | 10.4 |
| 13* | 87 | 0.4 | n.a. | n.a. | 8 | CU1 | 3 | CH1 | 34.5 |
| 14* | 87 | 0.4 | n.a. | n.a. | 8 | CU1 | 3 | CH1 | 103.5 |
| 15* | 87 | 0.4 | n.a. | n.a. | 8 | CU1 | 3 | n.a. | n.a. |
| 16 | 87 | 0.4 | agar | 0.15 | 8 | CU2 | 2 | CH2 | 300 |
| 17* | 87 | 0.4 | agar | 0.15 | 8 | CU2 | 2 | n.a. | n.a. |
| 18 | 87 | 0.4 | Citrus fiber | 0.5 | 8 | CU2 | 2 | CH2 | 500 |
| 19* | 87 | 0.4 | Citrus fiber | 0.5 | 8 | CU2 | 2 | n.a. | n.a. |

*comparative examples.

TABLE 2
Homogenization, pasteurization and fermentation
conditions for examples 1 to 19

| | | | Pasteurization (before | | |
|---|---|---|---|---|---|
| | Homogenization | | fermentation) conditions | | Fermentation |
| | conditions | | | Time | conditions |
| Ex. | T (° C.) | P (bar)* | T (° C.) | (minutes) | T (° C.) |
| 1 | 60-65 | 160/20 | 121 | 1 | at 43° C. until pH 4.5 |
| 2 | 60-65 | 160/20 | 121 | 1 | at 43° C. until pH 4.5 |
| 3 | 60-65 | 160/20 | 121 | 1 | at 43° C. until pH 4.5 |
| 4 | 60-65 | 160/20 | 121 | 1 | at 43° C. until pH 4.5 |
| 5 | 60-65 | 160/20 | 121 | 1 | at 43° C. until pH 4.5 |
| 6 | 60-65 | 160/20 | 121 | 1 | at 43° C. until pH 4.5 |
| 7 | 60-65 | 160/20 | 121 | 1 | at 43° C. until pH 4.5 |
| 8 | 60-65 | 160/20 | 121 | 1 | at 43° C. until pH 4.5 |
| 9 | 60-65 | 160/20 | 121 | 1 | at 43° C. until pH 4.5 |
| 10 | 60-65 | 160/20 | 121 | 1 | at 43° C. until pH 4.5 |
| 11 | 60-65 | 160/20 | 121 | 1 | at 43° C. until pH 4.5 |
| 12 | 60-65 | 160/20 | 121 | 1 | at 43° C. until pH 4.5 |
| 13 | 60-65 | 160/20 | 121 | 1 | at 43° C. until pH 4.5 |
| 14 | 60-65 | 160/20 | 121 | 1 | at 43° C. until pH 4.5 |
| 15 | 60-65 | 160/20 | 121 | 1 | at 43° C. until pH 4.5 |
| 16 | 60-65 | 200/40 | 90 | 10 | at 43° C. until pH 4.5 |
| 17 | 60-65 | 200/40 | 90 | 10 | at 43° C. until pH 4.5 |
| 18 | 60-65 | 200/40 | 90 | 10 | at 43° C. until pH 4.5 |
| 19 | 60-65 | 200/40 | 90 | 10 | at 43° C. until pH 4.5 |

*A two-stage homogenization with a first (higher) pressure and a second (lower) pressure is applied.

### Results of Examples 1 to 5 and Comparative Control Example 6

In examples 1 to 6 it was found that the addition of chymosin had no effect on the fermentation speed.

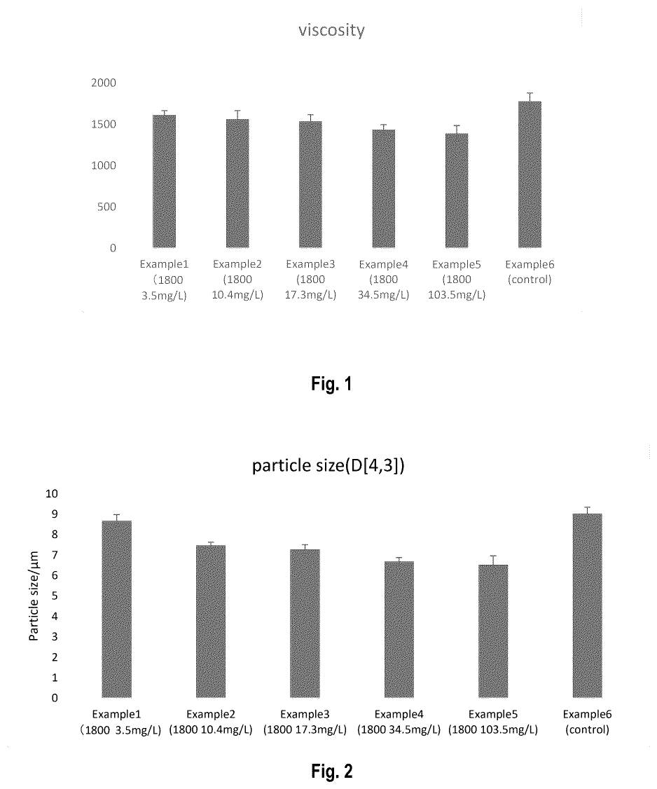

The apparent viscosity of the yogurts prepared in examples 1 to 6 was determined by using a Brookfield viscometer with rotor LV2 T-C at a rotation speed of 100 rpm (revolutions per minute) and applying a test time of about 90 seconds to 1 minute. The results for examples 1 to 6 are listed in Table 3 and illustrated in FIG. 1.

TABLE 3
Viscosity results of examples 1 to 6

| Example | 1 | 2 | 3 | 4 | 5 | 6 (control) |
|---|---|---|---|---|---|---|
| Viscosity (Brookfield) | 1616 | 1564 | 1539 | 1437 | 1392 | 1780 |

In addition, the particle size of the grains in the yoghurt was determined by means of laser diffraction, applying the sample between 10-12%, using a medium with a refractive index of 1.33, and reporting the average of 5 readings. The results for examples 1 to 6 are listed in Table 4 and illustrated in FIG. 2.

TABLE 4
Particle size results of examples 1 to 6

| Example | 1 | 2 | 3 | 4 | 5 | 6 (control) |
|---|---|---|---|---|---|---|
| particle size (D[4,3]) | 8.68 | 7.48 | 7.29 | 6.69 | 6.54 | 9.03 |

Further a sensory test was carried out with 15 test persons. In this sensory test graininess, lumpiness and smoothness were assessed. The results are reflected in Table 5 below.

TABLE 5
*Results of examples 1 to 6

| Item | Example 1 | Example 2 | Example 3 | Example 4 | Example 5 | Example 6 |
|---|---|---|---|---|---|---|
| graininess | ++ | ++ | + | − | − | +++++ |
| lumpiness | ++ | ++ | + | − | − | +++++ |
| smoothness | + | + | ++ | +++++ | +++++ | + |

*The sensory results are gathered based on 15 test persons.
More “+” means higher level of the corresponding item.

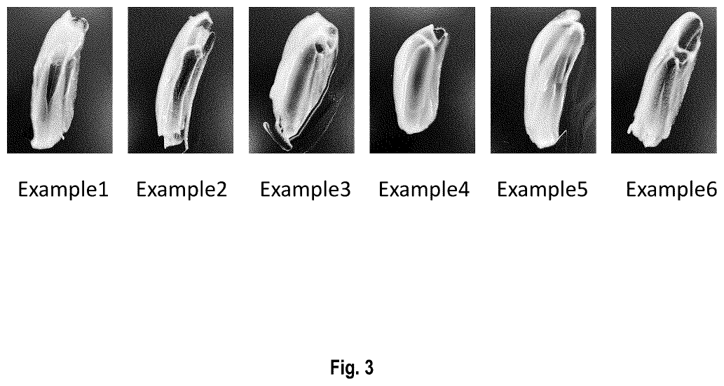

Last, the visual appearance of the yogurt was tested by swapping a small amount of yoghurt on a dark background. The visualization following such swapping for examples 1 to 6 has been provided in FIG. 3.

From the above results it was concluded that the yogurts of examples 1 to 5, which were prepared by applying the combination of stabilizer and chymosin during fermentation, showed smaller particle size, less grains and less lumps. In addition examples 3, 4 and 5 showed a smoother mouth feel. Viscosity merely decreased very slightly. The yogurt prepared in comparative control example 6 showed more grains, more lumps and had a less smooth mouthfeel.

From the visual results for the yogurts as presented in FIG. 3 it can be seen that the yogurts prepared by applying the combination of stabilizer and chymosin during fermentation are more delicate. The swap of the sample of the yogurt of comparative control example 6 showed more graininess.

### Results of Example 7 and Comparative Control Example 8

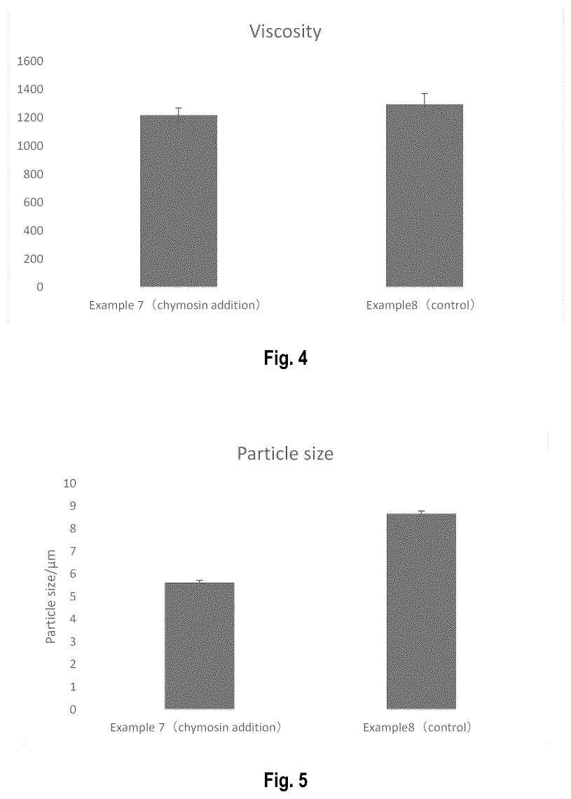

For example 7 and comparative control example 8, the apparent viscosity and particle size were determined in the same manner as for examples 1 to 6. The results have been listed in respectively Table 6 and Table 7 and have been illustrated in respectively FIG. 4 and FIG. 5.

When applying the combination of stabilizer and chimosin, the yoghurt showed smaller particle size compared to control with slightly decreasing in viscosity.

TABLE 6
Viscosity results of example 7 and comparative control example 8

| Example | 7 (chymosin addition) | 8 (control) |
|---|---|---|
| Viscosity | 1219 | 1296 |

TABLE 7
Particle size results of example 7
and comparative control example 8

| Example | 7 (chymosin addition) | 8 (control) |
|---|---|---|
| Particle size | 5.63 | 8.67 |

### Results of Example 9 and Comparative Control Example 10

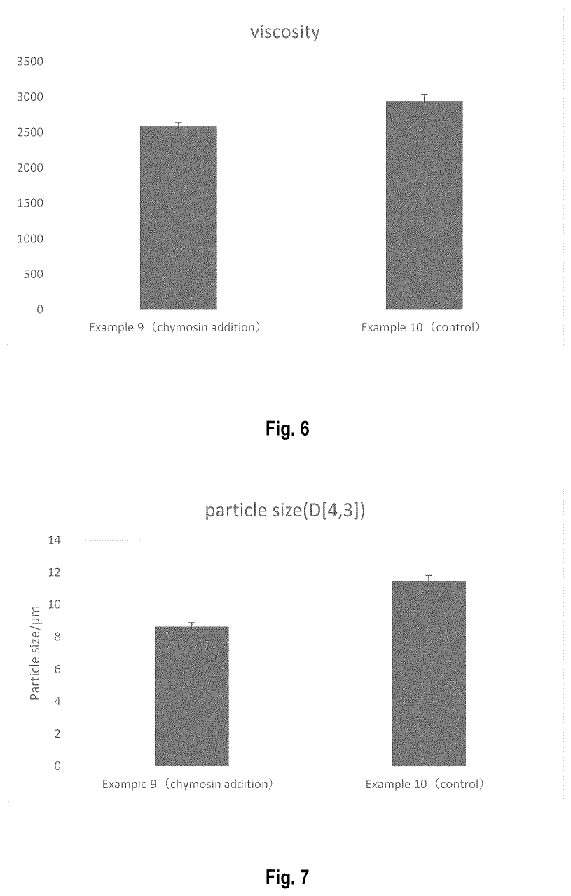

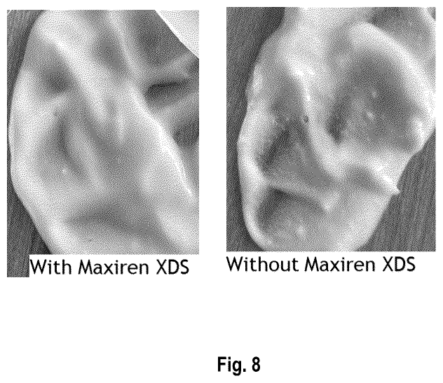

For example 9 and comparative control example 10, the apparent viscosity and particle size were determined in the same manner as for examples 1 to 6. The results have been listed in respectively Table 8 and Table 9 and illustrated in respectively FIG. 6 and FIG. 7. The visual appearance of the yogurt was tested by swapping a small amount of yoghurt on a dark background. The visualization following such swapping for examples 7 and 8 has been provided in FIG. 8.

The yogurt sample prepared by applying the combination of stabilizer and chymosin during fermentation (example 9) showed smaller particle size and smoother mouth feel with a decreasing viscosity. The addition of chymosin had no effect on the fermentation speed.

The yogurt sample prepared by applying the combination of stabilizer and chymosin during fermentation (example 9) was also more delicate whilst the yogurt sample prepared in comparative control example 10 had some more graininess.

TABLE 8
Viscosity results of example 9 and comparative control example 10

| Example | 9 (chymosin addition) | 10 (control) |
|---|---|---|
| viscosity | 2592 | 2944 |

TABLE 9
Particle size results of example 9
and comparative control example 10

| Example | 9 (chymosin addition) | 10 (control) |
|---|---|---|
| particle size (D[4, 3]) | 8.65 | 11.5 |

### Results of Comparative Control Examples 11 to 15 (without Stabilizer)

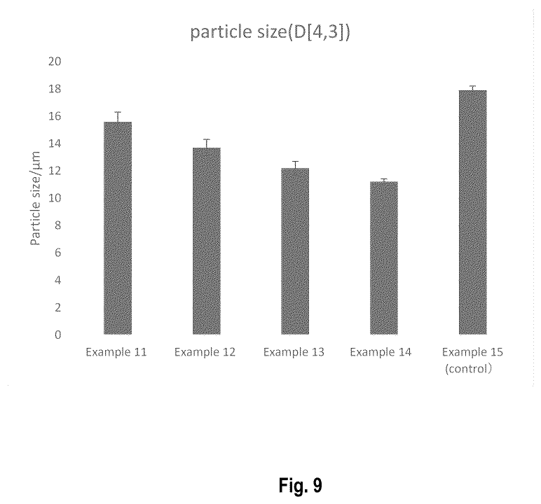

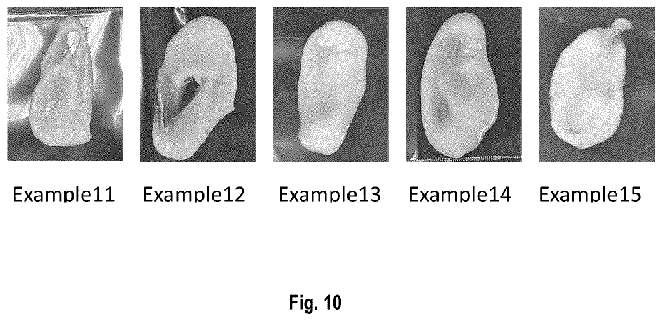

For comparative control examples 11 to 15 (without stabilizer), the particle size was determined in the same manner as for examples 1 to 6. The results have been listed in Table 10 and illustrated in FIG. 9. FIG. 9 illustrates that the particle size was decreasing with the increasing dosage of chymosin. However, compared with the system with stabilizers in example 1-5, the particle size remained bigger even at the highest dosage of chymosin. Also the visual observations as illustrated in FIG. 10 show the remaining presence of graininess.

TABLE 10
Particle size results of control examples
11 to 15 (without stabilizer)

| | | | | | 15 |
|---|---|---|---|---|---|
| Example | 11 | 12 | 13 | 14 | (without Chymosin) |
| particle size (D[4, 3]) | 15.6 | 13.7 | 12.2 | 11.22 | 17.9 |

### Results of Example 16 and Comparative Control Example 17

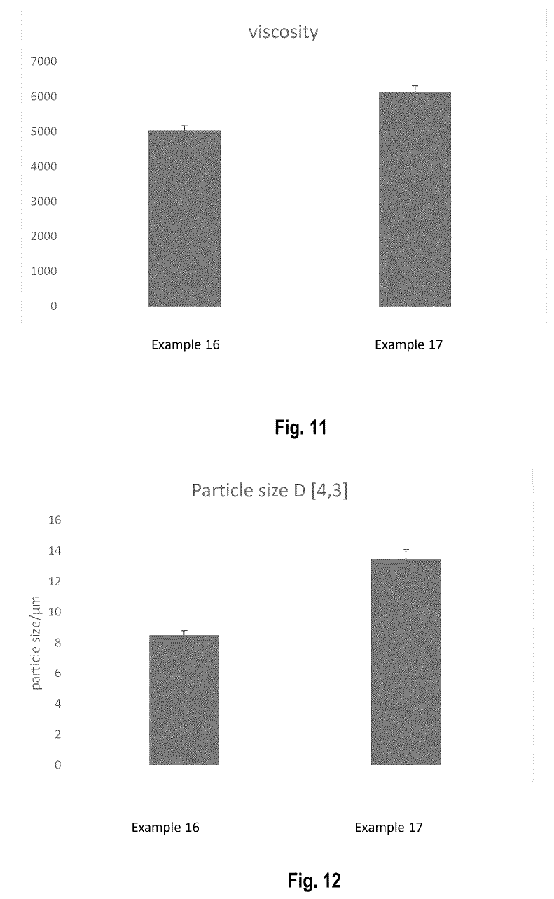

For example 16 and comparative control example 17 the apparent viscosity and particle size were determined in the same manner as for examples 1 to 6. The results have been listed in respectively Table 11 and Table 12 and illustrated in respectively FIG. 11 and FIG. 12. The yogurt sample prepared by applying the combination of stabilizer and chymosin during fermentation in example 16 showed smaller particle size and a somewhat decreased viscosity vis-à-vis the yoghurt sample of comparative control example 17.

TABLE 11
Viscosity results of example 16 and
comparative control example 17

| Example | 16 (chymosin addition) | 17 (control) |
|---|---|---|
| viscosity | 5029 | 6141 |

TABLE 12
Particle size results of example 16
and comparative control example 17

| Example | 16 (chymosin addition) | 17 (control) |
|---|---|---|
| particle size (D[4, 3]) | 8.5 | 13.5 |

### Results of Example 18 and Comparative Control Example 19

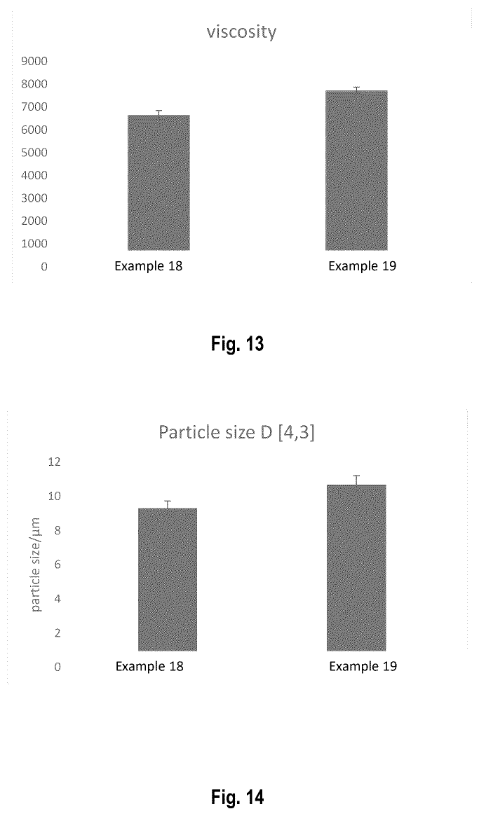

For example 18 and comparative control example 19, the apparent viscosity and particle size were determined in the same manner as for examples 1 to 6. The results have been listed in respectively Table 13 and Table 14 and illustrated in respectively FIG. 13 and FIG. 14.

The yogurt sample prepared by applying the combination of stabilizer and chymosin during fermentation in example 18 showed smaller particle size and a somewhat decreased viscosity vis-à-vis the yoghurt sample of comparative control example 19.

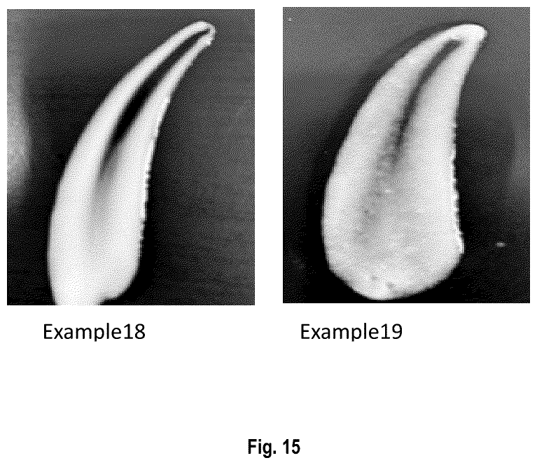

From the visual results for the yogurts as presented in FIG. 15. It can be seen that the yogurts prepared by applying the combination of stabilizer and chymosin during fermentation (example 18) are also more delicate. The swap of the sample of the yogurt of comparative control example 19 showed more graininess.

TABLE 13
Viscosity results of example 18 and
comparative control example 19

| Example | 18 (chymosin addition) | 19 (control) |
|---|---|---|
| viscosity | 6649 | 7723 |

TABLE 14
Particle size results of example 18
and comparative control example 19

| Example | 18 (chymosin addition) | 19 (control) |
|---|---|---|
| particle size (D[4, 3]) | 9.31 | 10.7 |

### Example 20 (Same Recipe and Process of Example 3 with Different Chymosin)

A milk-base and fermented milk product was prepared in the same manner as described herein before for example 3, except that a different chymosin was used. The chymosin used in this example 20 was CHY-MAX-Powder Extra NB, commercially obtainable from Chr. Hansen, Denmark. The chymosin was applied in a dosage of 60 mg/L.

Results were similar to the results in examples 1-5. Also here the fermented milk product, that is the prepared yogurt, showed a smaller particle size and smoother mouth feel with a decreasing viscosity.

### Example 21 (Same Recipe and Process of Example 3 with Different Culture)

A milk-base and fermented milk product was prepared in the same manner as described herein before for example 3, except that a different culture was used. The culture used in this example 21 was YF-L904, commercially obtainable from Chr. Hansen, Denmark.

Results were similar to the results in examples 1-5. Also here the fermented milk product, that is the prepared yogurt, showed a smaller particle size and smoother mouth feel with a decreasing viscosity.

### Example 22 (Same Recipe and Process of Example 3 with Different Culture)

A milk-base and fermented milk product was prepared in the same manner as described herein before for example 3, except that a different culture was used. The culture used in this example 21 was GS122, commercially obtainable from Chr. Hansen, Denmark.

Results were similar to the results in examples 1-5. Also here the fermented milk product, that is the prepared yogurt, showed a smaller particle size and smoother mouth feel with a decreasing viscosity.

1. A process for the production of a fermented milk product, optionally a yogurt, comprising the steps of:
a) fermenting the milk-base with one or more lactic acid bacterial strains, a coagulant and a stabilizer to produce a fermented milk product;
b) heat treating the fermented milk product at a temperature of at least 70° C. for a period of at least 5 seconds to produce a heat-treated fermented milk product; and
(c) storing the pasteurized fermented milk product at a temperature in the range from equal to or more than 10° C. to equal to or less than 40° C.

2-12. (canceled)

13. The process according to claim 1, wherein the coagulant comprises or consists of a polypeptide having chymosin activity.

14. The process according to claim 2, wherein the polypeptide having chymosin activity is present in a concentration of at least 10 mg polypeptide per liter milk-base.

15. The process according to claim 1, wherein the coagulant is a polypeptide having chymosin activity which is produced in a microorganism.

16. The process according to claim 1, wherein the milk base is fermented with a starter culture blend comprising one or more lactic acid bacterial strains.

17. The process according to claim 5, wherein the starter culture blend comprises at least one strain of Streptococcus salivarius thermophilus and at least one strain of Lactobacillus delbruekii subsp. bulgaricus.

18. The process according to claim 1, wherein the stabilizer is selected from the group consisting of agar, alginate, alginic acid, betaglucan, carrageenan, chitin, chitosan, gelatin, gellan gum, guar gum, gum arabic, gum tragacanth, konjac gum, locust bean gum, pectate, pectin, pectinate, propylene glycol-alginate, scleroglucan, xanthan gum, microcrystalline cellulose, hydroxypropyl cellulose, hydroxypropyl methylcellulose, hydroxyethyl cellulose, carboxymethyl cellulose, methylcellulose, ethylcellulose, starch, carboxymethyl starch, hydrophobically modified starch, mono-, di-, or triglycerides of fatty acids, lactic acid esters of mono- and diglycerides, diacetyl tartaric acid esters of mono- and diglycerides, polyglycerol esters of fatty acid, sodium stearolyl lactylate, hexaglyceryl distearate, lecithin, hydroxylated lecithin, a polyoxyethylene ether of fatty esters of polyhydric alcohols (i.e., a polysorbate, such as polysorbate 80), sucrose esters, and combinations thereof.

19. The process according to claim 1, wherein the milk-base is further supplemented with sucrose.

20. The process according to claim 8, wherein the sucrose is present in a concentration of at least 5% wt/wt, based on the total weight of milk-base.

21. A kit of parts comprising
one or more lactic acid bacterial strain(s) comprising at least one strain of Streptococcus salivarius thermophilus and at least one strain of Lactobacillus delbruekii subsp. bulgaricus;
a coagulant having chymosin activity; and
a stabilizer.

22. The kit of parts of claim 9, wherein at least one part of the kit is in the form of separate frozen or freeze-dried pellets.

23. A process for the preparation of an ambient yogurt comprising fermenting a milk-base in the presence of the kit of parts of claim 10 and heat treating the fermented milk product at a temperature of at least 70° C. for a period of at least 5 seconds to produce a heat-treated fermented milk product.

24. A fermented milk product, optionally a yogurt, comprising: (i) one or more inactivated lactic acid bacterial strains; (ii) one or more inactivated coagulants; and (iii) a stabilizer.

25. A yogurt obtainable by the process of claim 12, wherein the particle size in the yogurt is decreased by at least 13% as compared to the respective yogurt without the addition of a coagulant as part of the kit.
